(19) United States
(12) Patent Application Publication
(10) Pub. No.: US 2026/0208927 A1
(43) Pub. Date: Jul. 23, 2026

(54) CAPSULE DISPENSING ACTUATOR AND ASSOCIATED SYSTEM AND BOTTLE

(71) Applicant: MYPANGU PTY LTD, St Arnaud, Victoria (AU)

(72) Inventor: Peter BLOOMFIELD, St Arnaued (AU)

(73) Assignee: MYPANGU PTY LTD, St Arnaud, Victoria (AU)

(21) Appl. No.: 19/140,131

(22) PCT Filed: Dec. 18, 2023
(86) PCT No.: PCT/AU2023/051327

§ 371 Date: Jun. 17, 2025

(30) Foreign Application Priority Data
Dec. 19, 2022 (AU) 2022903889

(51) Int. Cl. B65D 51/28; A61J 9/00; A61J 11/00; B65D 81/32

(52) U.S. Cl. CPC B65D 51/2835; A61J 9/008; A61J 11/0095; B65D 81/3211; B65D 81/3233

(57) ABSTRACT

An actuator for piercing a capsule with a consumable product sealed therein and for dispensing the pierced capsule into a container, an upper end of the capsule being sealed and having an outwardly extending brim which, in use, is arranged within a rim associated with a mouth of the container, wherein the actuator is operated by a closure that is threadingly engageable with the container to urge the actuator against the capsule, the actuator having: one or more downwardly extending blades configured to pierce the seal of the capsule during rotation of the closure toward the capsule; and a bearing surface configured to increasingly bear against the brim of the capsule as the closure is rotated so as to urge the pierced capsule to drop through the rim into the container.

### FIELD OF THE INVENTION

Disclosed herein is an actuator configured to pierce a capsule with a consumable product sealed therein, such as a powdered material or a liquid concentrate. The actuator is also configured to dispense the pierced capsule into a container such as a bottle. Also disclosed herein is a system for dispensing a consumable product into a container, along with a bottle comprising said actuator.

The arrangements disclosed herein may find application in relation to consumer drinks, such as baby formula or sports drinks, though other markets such as cleaning products for example may also be applicable.

### BACKGROUND

Many drinks and beverages are prepared by mixing a consumable product, such as a powdered material or a liquid concentrate, with a liquid. For example, milk for consumption by infants might be prepared by mixing milk powder and water in a bottle.

Similarly, protein shakes are regularly prepared by mixing water or milk with a protein powder.

However, it is often difficult and/or inconvenient to measure the precise amount of the consumable product required. Additionally, since such consumable products are typically purchased and stored in bulk, it can be difficult or unfeasible to access the consumable product and carefully measure a required dose if one is on the go.

Alternatively, if one measures the consumable product out beforehand, the consumable product is typically stored within an empty container such as a drink bottle, which means the bottle cannot first be filled with the desired liquid for mixture with the consumable product (since the resulting mixture should be consumed soon after mixing). As such, one must either carry an additional container with the liquid for mixing or locate a liquid source while out and about.

There is a need to address the above, and/or at least provide a useful alternative.

### SUMMARY

According to a first aspect of the present invention, there is provided an actuator for piercing a capsule with a consumable product sealed therein and for dispensing the pierced capsule into a container, an upper end of the capsule being sealed and having an outwardly extending brim which, in use, is arranged within a rim associated with a mouth of the container, wherein the actuator is operated by a closure that is threadingly engageable with the container to urge the actuator against the capsule, the actuator having:
one or more downwardly extending blades configured to pierce the seal of the capsule during rotation of the closure toward the capsule; and
a bearing surface configured to increasingly bear against the brim of the capsule as the closure is rotated so as to urge the pierced capsule to drop through the rim into the container.

The actuator may comprise a downwardly extending collar, a bottom of which comprises the bearing surface, the collar having a first section that extends downwardly to a first extent and an opposite second section that extends downwardly to a second extent which is greater than the first extent such that, in use, the bearing surface at the second section of the collar is configured to urge against the brim of the capsule as the closure is rotated relative to the container and toward the capsule.

In certain embodiments, at least one blade extends downwardly from the first end of the collar such that, as the top is rotated toward the capsule, the at least one blade pierces the capsule and then the bearing surface at the second end of the collar presses the pierced capsule through the rim and into the container.

It is envisaged that the actuator may have a generally circular shape, wherein the or each blade is radially spaced from a centre of the actuator so that, in use, as the closure is rotated to close the container, the actuator is correspondingly rotated such that the or each blade pierces the seal and cuts therethrough along a curvilinear path corresponding to that of an inner circumference of the brim of the capsule.

In example embodiments, the actuator comprises comprising an annular top from which the collar downwardly extends which is receivable within or integrally formed with a neck of the closure such that rotation of the closure rotates the actuator.

In certain example embodiments, the rim comprises an outwardly extending circumferential lip configured to sit on a lip of the mouth of the container, and an inwardly extending circumferential ledge on which the brim of the capsule is configured to sit before being urged therepast by the actuator bearing upon the brim of the capsule.

According to a second aspect of the present invention, there is provided a system for dispensing a consumable product into a container, comprising:
an actuator according to a first aspect of the present invention;
a capsule containing the consumable product therein, an upper end of the capsule being sealed and having an outwardly extending brim which, in use, is arranged within a rim associated with a mouth of the container; and
a closure that is threadingly engageable with the container to urge the actuator against the capsule,
wherein in use, rotation of the closure toward the capsule arranged within the rim is configured to:
   drive the or each blade of the actuator to pierce the seal of the capsule; and
   increasingly bear the bearing surface of the actuator against the brim of the capsule so as to urge the pierced capsule to drop through the rim into the container, releasing the unsealed consumable product therein.

In certain embodiments of the system, the rim comprises an outwardly extending circumferential lip configured to sit on a lip of the mouth of the container, and an inwardly extending circumferential ledge on which the brim of the capsule is configured to sit before being urged therepast by the actuator bearing upon the brim of the capsule. It is envisaged that the consumable product comprises a powdered material or a liquid concentrate and that the container comprises a bottle in which the powdered material or liquid concentrate dispensed from the dropped capsule can be mixed with a liquid.

According to a third aspect of the present invention, there is provided a container closure comprising an actuator according to the first aspect of the present invention. In certain embodiments, the actuator may be integrally formed within an underside of the closure.

According to a fourth aspect of the present invention, there is provided a baby bottle comprising:
an actuator according to a first aspect of the present invention; or
a system according to a second aspect of the present invention.

### BRIEF DESCRIPTION OF THE DRAWINGS

An embodiment of the invention will now be described, by way of example only, with reference to the accompanying drawings in which:

FIG. 1 is an exploded assembly view of a baby bottle comprising an actuator and associated system for dispensing a consumable product into a container according to embodiments of the present invention;

FIG. 2 is a close-up of the actuator, capsule and rim of the assembly of FIG. 1;

FIG. 3A is a side perspective view showing the rim sitting within a mouth of the bottle of FIG. 1;

FIG. 3B is a side perspective view of FIG. 3A, wherein the capsule of FIG. 2 is shown arranged within the rim;

FIGS. 4A to 4C are, respectively, side, bottom perspective, and front views of the actuator of FIG. 2;

FIG. 5A is a bottom view of a closure for the bottle of FIG. 1;

FIG. 5B is a bottom view of the closure of FIG. 5A with the actuator of FIG. 4A inserted therein;

FIG. 6A is a side view of the assembly of FIG. 1 in an assembled state, prior to the closure being operated to pierce and dispense the capsule into the bottle;

FIG. 6B is a top perspective view of the assembly of FIG. 6A after the capsule has been pierced and dispensed into the bottle;

FIGS. 7A and 7B are, respectively, top perspective and side views of the actuator and capsule.

### DETAILED DESCRIPTION

Rather than manually scooping out potentially inaccurate and messy volumes of powdered material or liquid concentrates from a bulk storage container, the present patent specification envisages that the consumable product can be accurately pre-measured and sealed within a capsule. This capsule can then be easily transported by the user, particularly with a container that already contains the desired liquid for mixture with the consumable product. As such, when convenient, the capsule can simply be unsealed, and the consumable product therein can be dispensed into the container for mixture with the liquid already in the container. To this end, the present patent specification relates to an actuator 2 and an associated system 14 via which a user can open the seal of a capsule 4 such that the consumable product therein can be dispensed into the container 6. It is envisaged that the actuator 2 can be inserted into or be integrally formed with a closure 8 of the container 6, whereby in operating the closure 8 (e.g., screwing the closure 8 onto the container 6 to close it), the actuator 2 acts to pierce through a seal of the capsule 4 and to urge against the pierced capsule 4 so that it drops into the container 6. Advantageously, the capsule 4 is made from a food-safe material and can be dispensed directly into the liquid in the container 6 whereby the capsule 4 can function as an agitator to promote mixing of the consumable product and liquid within the container 6 (e.g., via shaking of the container 6). An embodiment of the present actuator 2 and associated system, along with a baby bottle comprising said actuator 2 and associated system 14, will now be described to expand upon the present teachings. Henceforth, the consumable product will be referred to as a powdered material (such as milk powder), though it will be appreciated that other consumable products, such as liquid concentrates and the like, may also be sealed within the capsule 4 and that actuators 2, systems 14 and closures directed toward unsealing and/or dispensing such capsules are within the scope of the present specification.

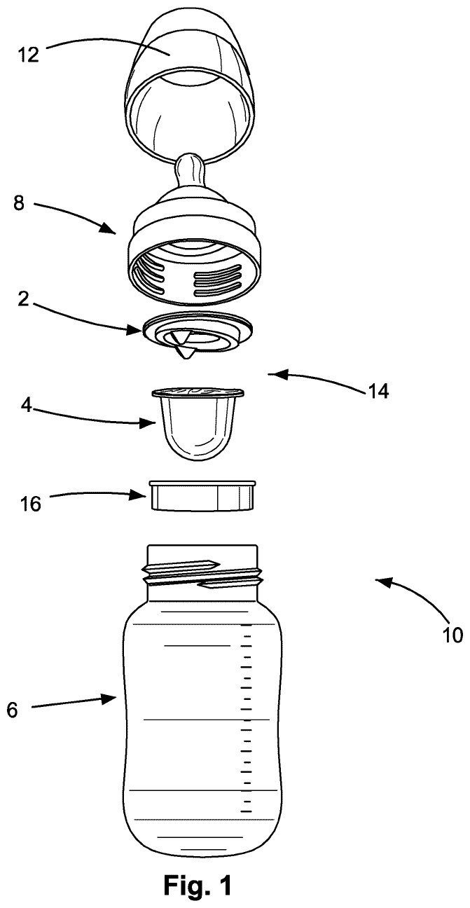

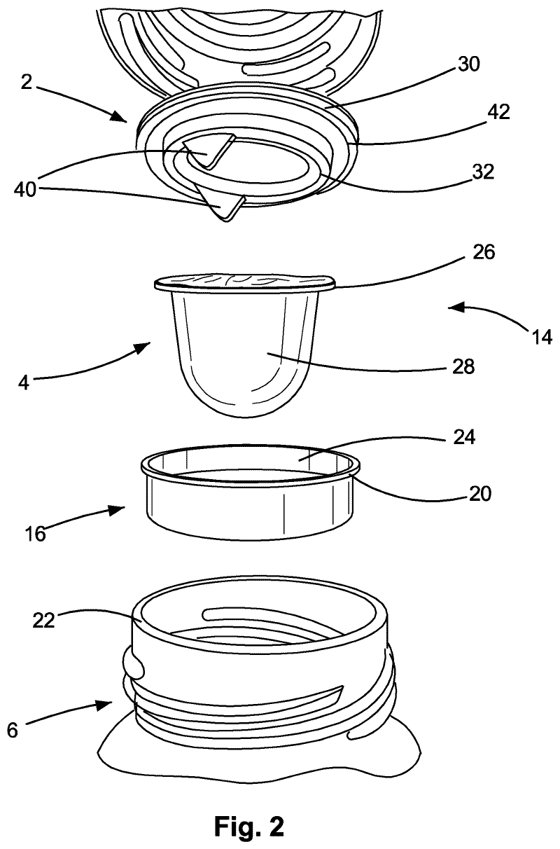

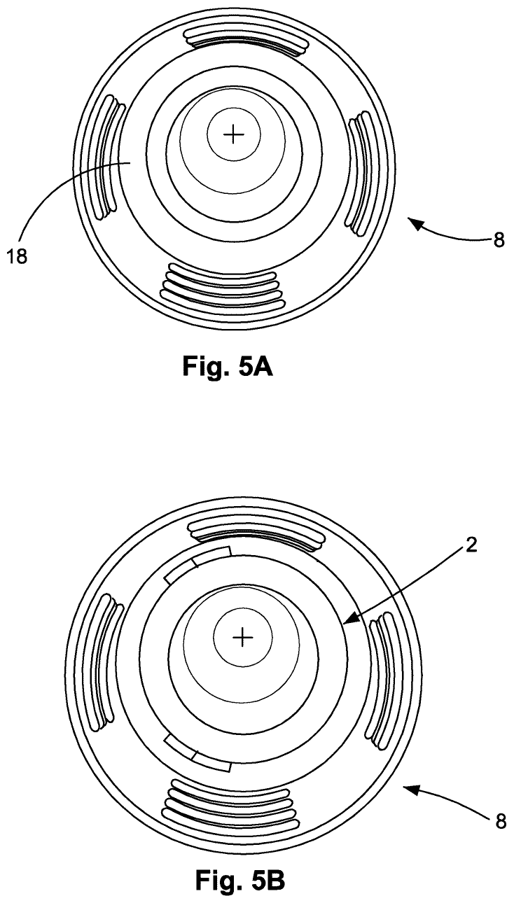

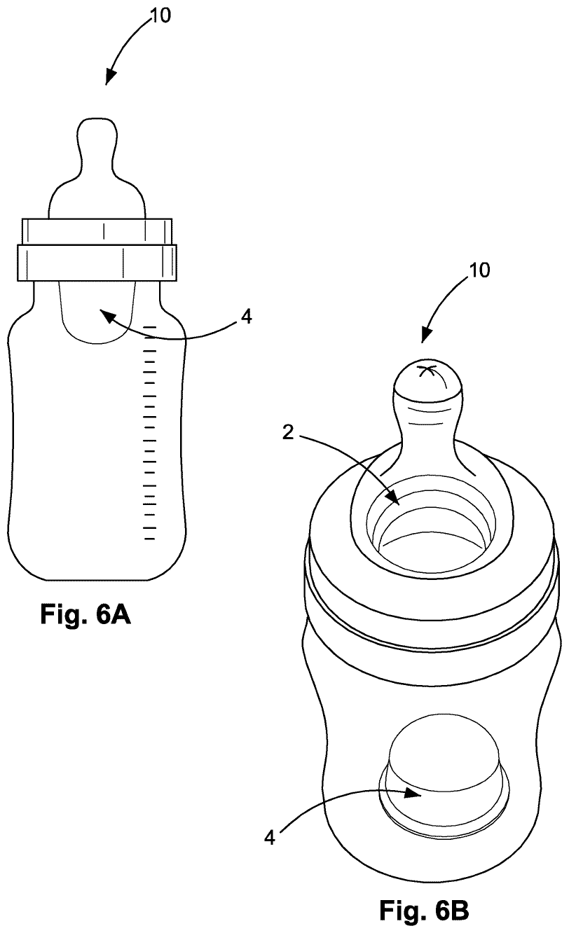

FIG. 1 shows an exploded view of a baby bottle 10 comprising a container 6, a closure 8, and a hygienic cover 12 for the closure 8. The present system 14 for dispensing a powdered material into the bottle 6 is shown in this exploded view, along with FIG. 2. In the depicted embodiment, the system 14 comprises the actuator 2, a capsule 4 containing the powdered material, and a rim 16 (which rim can be a separate component or constitute the mouth of the container 6). The actuator 2 is receivable within an underside 18 of the closure 8 (see FIGS. 5A and 5B) and is operable via rotation of the closure 8 (i.e., to screw threadingly close the bottle 6) to cut through the seal of the capsule 4 and to push the pierced capsule 4 into the container bottle 6.

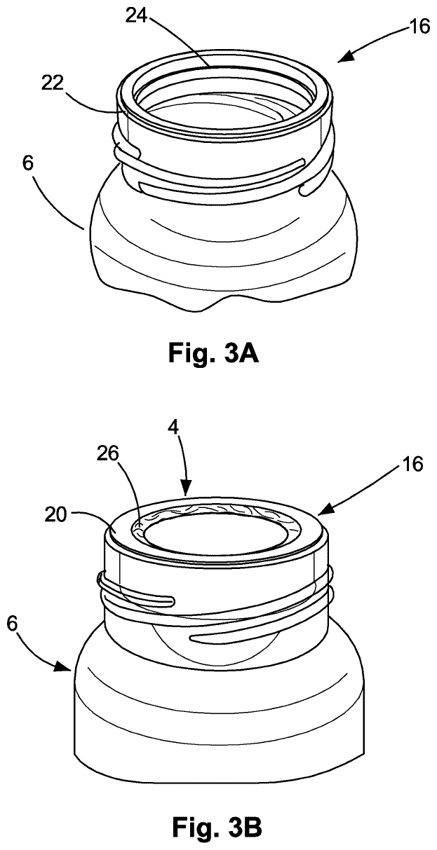

Referring to FIG. 2, the rim 16 is a substantially ring-shaped component that, in use, is configured to sit within the mouth of the bottle 6. In particular, an upper end of the rim 16 has an outwardly extending circumferential lip 20 sized to sit on the lip 22 of the mouth of the bottle 6, as shown in FIG. 3A. An internal surface of the rim 16 is provided with an inwardly extending circumferential ledge 24 configured to receive a brim 26 of the capsule 4.

As can be seen in FIG. 2, the capsule 4 has a dome-shaped body 28 in which the powdered material can be stored, and a relatively flat upper end which is sealed via conventional means. The upper end comprises an outwardly extending brim 26 configured to sit on the inwardly extending ledge 24 of the rim component 16, as shown in FIG. 3B. The rim 16 and ledge 24 are configured to facilitate easy alignment and location of the capsule 4 thereon, with the capsule body 28 extending through the rim 16 and the brim 26 of the capsule 4 sitting flush on the inner ledge 24 of the rim component 16. In this way, even if the container 6 is tilted, the capsule 4 remains square with the container 6.

Of course, the present system need not utilise a separate rim component 16 and it is within the scope of the present specification that the brim 26 of the capsule 4 can simply sit on the lip 22 of the mouth of the container 6. While the brim 26 of the capsule 4 can sit relatively securely on the ledge 24 of the rim 16, as will be discussed, the actuator 2 is configured to push or urge the capsule 4 through the rim 16 so that the capsule 4 can drop into the container 6 after it has been pierced. As such, the material of the brim 26 of the capsule 4 and/or the ledge 24 of the rim 16 should be at least slightly deformable so that the brim 26 of the capsule 4 can be pushed past the ledge 24 of the rim component 16.

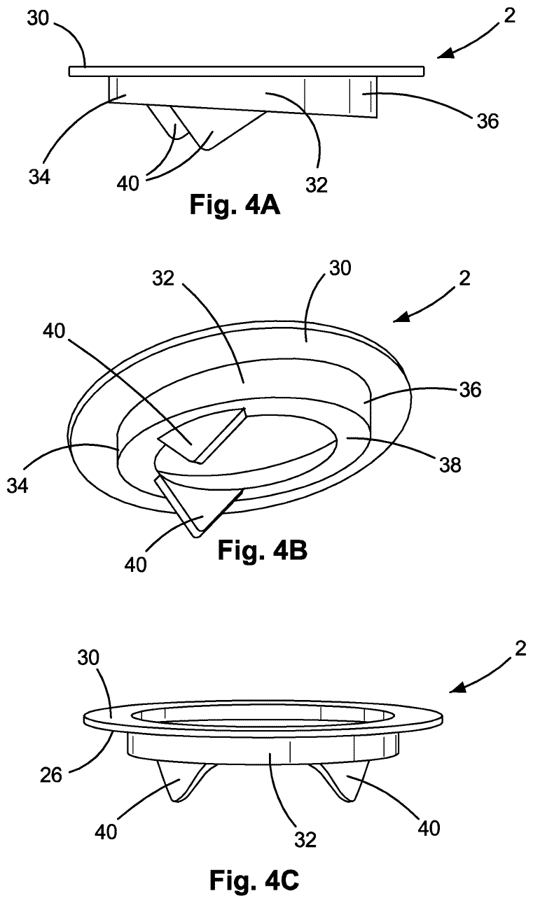

FIGS. 4A to 4C show various views of the actuator 2. While the actuator 2 is depicted as a separate component in the Figures, this is simply an example embodiment for illustrative purposes, and it is certainly within the scope of the present specification that the actuator 2 can be integrally formed with the closure 8 of the container 6 and need not be a separate component received or inserted therein.

In the depicted embodiment, the actuator 2 comprises an annular upper end 30 sized to be received within a neck of the closure 8, as shown in FIG. 5B. Preferably, the annular upper end 30 has a generally flat upper surface which may be received in a flush manner against an upper end of the closure 8 inside the neck thereof. The actuator 2 also comprises a collar 32 that extends downwardly from the annular upper end 30.

Referring to FIG. 4A, the collar 32 is not entirely symmetrical. In particular, the collar 32 has a first section 34 that extends downwardly to a first extent, and a second section 36 that extends downwardly to a second extent, the second extent being greater than the first extent. Referring in particular to FIG. 4A, the collar 32 has a slope or an angle; e.g., the collar slopes downwardly along its circumference from the first section to the second section. In other words, the collar can be thought of as being in the shape of a short hollow cylinder which has been cut along an angled plane that is transverse to the longitudinal axis of the cylinder. As will be discussed, the sloped profile of the collar 32 is important for ensuring that the capsule 4 is first pierced before it is urged through the rim 16 and into the container 6.

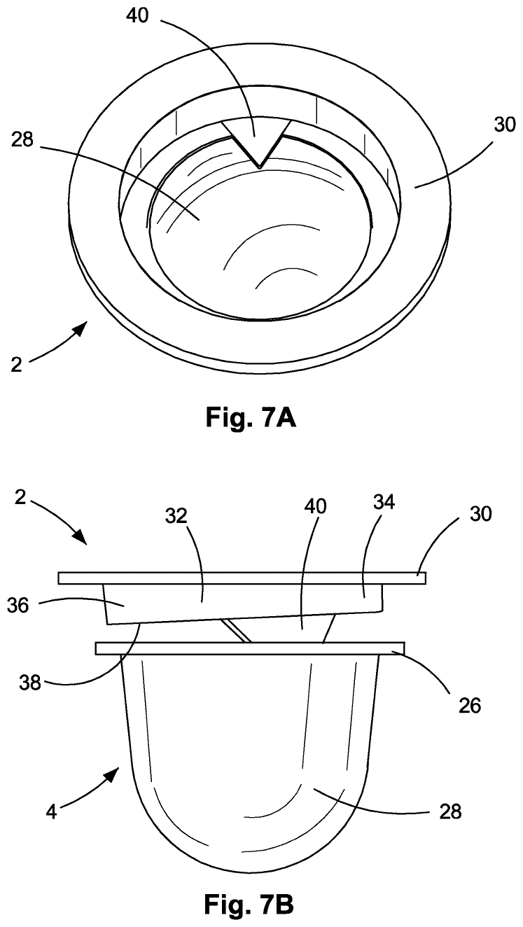

Referring to FIG. 4B, the lower ring-shaped surface of the collar 32 constitutes a bearing surface 38 configured to bear against the brim 26 of the capsule 4 to urge or press against it and push it through the rim 16 and into the container 6. However, it is crucial to ensure that the capsule 4 is sufficiently pierced and/or opened before it drops into the container 6, otherwise, the capsule 4 may still be substantially sealed when it is dispensed into the container 6, in which case the powdered material therein would not be sufficiently released for mixture with liquid within the container 6. To this end, the actuator 2 comprises a pair of blades 40 extending downwardly from the collar 32. In particular, the blades 40 are located toward or at the first section 34 of the collar 32. As such, and with reference to FIG. 7B, as the closure 8 is rotated, the actuator 2 is advanced toward the capsule 4 wherein the blades 40 at the first section 34 of the collar 32 first contact and pierce through the seal of the capsule 4. As the closure 8 and thus actuator 2 continue to be rotated, the blades 40 cut through at least a portion of the seal along a curvilinear path corresponding to an inner circumference of the brim 26 of the capsule 4. Meanwhile, the bearing surface 38 of the collar 32 at the second section 36 thereof is advanced toward the brim 26 of the capsule 4, whereupon after the capsule 4 has been pierced and possibly sliced through to a certain extent, the bearing surface 38 at the taller second section 36 of the collar 32 is driven into the brim 26 of the capsule 4 to increasingly bear against the brim 26 during further rotation of the closure 8. This downward bearing of the bearing surface 38 on the brim 26 of the capsule 4 presses downwardly on the capsule 4 so as to push the capsule 4 through the rim 16 (i.e., the brim 26 of the capsule 4 is urged past the ledge 24 of the rim 16 upon which it sits) and into the container 6, whereupon the powdered material within the pierced capsule 4 can be released for mixture in the container 6. It will be appreciated that the angled bearing surface 38 applies pressure at a generally local point of the brim 26 to tilt and push the capsule 4 through the rim 16 with a generally low amount of force. Were the bearing surface to be flat, the full circumference of the brim 26 would need to pass through the rim 16 which would require a greater force. To this end, the circumferential ledge 24 of the rim 16 may be angled (e.g., around 45°) such that, when the system 14 is assembled for use, the bearing surface 38 of the second section 36 of the actuator 2 engages and pushes against the brim 26 of the capsule 4 with a normal force when the closure 8 is operated. In other words, the bearing surface 38 acts to push directly downwardly on the capsule 4.

Many modifications of the above embodiments will be apparent to those skilled in the art without departing from the scope of the present invention. For example, while the depicted actuator 2 comprises blades 40 that extend downwardly from the collar 32, it is envisaged that the blade may simply be formed as an edge of the collar which is sharp enough to pierce through the seal of the capsule. In this embodiment, the collar may have a relatively sharp and/or thin first section configured to pierce the capsule, and an opposed second section which is thicker and comprises a bearing surface configured to bear upon the brim 26 of the capsule 4.

It is envisaged that a liquid seal may be provided to prevent leakage from the bottle 10 during use. For example, with reference to FIG. 2, an elastomeric food grade seal 42 is provided around the collar 32 of the actuator. In use, the seal 42 seals against the rim 16 (whether that be the separate rim component 16 or the rim of the mouth of the bottle 6) to ensure that the liquid mixture within the bottle 6 does not leak therefrom. Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. An actuator for piercing a capsule with a consumable product sealed therein and for dispensing the pierced capsule into a container, an upper end of the capsule being sealed and having an outwardly extending brim which, in use, is arranged within a rim associated with a mouth of the container, wherein the actuator is operated by a closure that is threadingly engageable with the container to urge the actuator against the capsule, the actuator having:
one or more downwardly extending blades configured to pierce the seal of the capsule during rotation of the closure toward the capsule; and
a bearing surface configured to increasingly bear against the brim of the capsule as the closure is rotated so as to urge the pierced capsule to drop through the rim into the container.

2. The actuator of claim 1, comprising a downwardly extending collar, a bottom of which comprises the bearing surface, the collar having a first section that extends downwardly to a first extent and an opposite second section that extends downwardly to a second extent which is greater than the first extent such that, in use, the bearing surface at the second section of the collar is configured to urge against the brim of the capsule as the closure is rotated relative to the container and toward the capsule.

3. The actuator of claim 2, wherein at least one blade extends downwardly from the first end of the collar such that, as the top is rotated toward the capsule, the at least one blade pierces the capsule and then the bearing surface at the second end of the collar presses the pierced capsule through the rim and into the container.

4. The actuator of claim 1, having a generally circular shape, wherein the or each blade is radially spaced from a centre of the actuator so that, in use, as the closure is rotated to close the container, the actuator is correspondingly rotated such that the or each blade pierces the seal and cuts therethrough along a curvilinear path corresponding to that of an inner circumference of the brim of the capsule.

5. The actuator of claim 4, comprising an annular top from which the collar downwardly extends which is receivable within or integrally formed with a neck of the closure such that rotation of the closure rotates the actuator.

6. The actuator of claim 1, wherein the rim comprises an outwardly extending circumferential lip configured to sit on a lip of the mouth of the container, and an inwardly extending circumferential ledge on which the brim of the capsule is configured to sit before being urged therepast by the actuator bearing upon the brim of the capsule.

7. A system for dispensing a consumable product into a container, comprising:
an actuator according to any one of the preceding claims;
a capsule containing the consumable product therein, an upper end of the capsule being sealed and having an outwardly extending brim which, in use, is arranged within a rim associated with a mouth of the container; and
a closure that is threadingly engageable with the container to urge the actuator against the capsule,
wherein in use, rotation of the closure toward the capsule arranged within the rim is configured to:
drive the or each blade of the actuator to pierce the seal of the capsule; and
increasingly bear the bearing surface of the actuator against the brim of the capsule so as to urge the pierced capsule to drop through the rim into the container, releasing the unsealed consumable product therein.

8. The system of claim 7, wherein the rim comprises an outwardly extending circumferential lip configured to sit on a lip of the mouth of the container, and an inwardly extending circumferential ledge on which the brim of the capsule is configured to sit before being urged therepast by the actuator bearing upon the brim of the capsule.

9. The system of claim 7, wherein the consumable product comprises a powdered material or a liquid concentrate and the container comprises a bottle in which the powdered material or liquid concentrate dispensed from the dropped capsule can be mixed with a liquid.

10. A container closure comprising the actuator of claim 1.

11. The closure of claim 10, wherein the actuator is integrally formed within an underside of the closure.

12. A baby bottle comprising:
an actuator according to claim 1.
